(19) United States
(12) Patent Application Publication
(10) Pub. No.: US 2011/0205065 A1
(43) Pub. Date: Aug. 25, 2011

(54) ANALYTE TESTING METHOD AND SYSTEM WITH SAFETY WARNING FOR INSULIN DOSING

(75) Inventors: Alexander STRACHAN, Inverness (GB); Gillian Teft, Maryburgh (GB); Robert Cavaye, Penarth (GB); Eric Bergman, Menlo Park, CA (US)

(73) Assignee: LifeScan Scotland Ltd., Inverness-shire (GB)

(21) Appl. No.: 12/826,567

(22) Filed: Jun. 29, 2010

Related U.S. Application Data
(60) Provisional application No. 61/308,196, filed on Feb. 25, 2010.

(51) Int. Cl. G08B 23/00

(52) U.S. Cl. 340/573.1

(57) ABSTRACT

Methods and systems to provide for safeguards in the insulin dosing calculation as part of the diabetes management. The system or method provides a warning if the person with diabetes is calculating a dosing regimen outside of a preselected time period in which certain dosing parameters are customized to the preselected time period.

This application claims the benefits of priority under 35 USC §119 and/or §120 from prior filed U.S. Provisional Application Ser. No. 61/308,196 filed on Feb. 25, 2010, which application is incorporated by reference in its entirety into this application.

### BACKGROUND

Glucose monitoring is a fact of everyday life for diabetic individuals. The accuracy of such monitoring can significantly affect the health and ultimately the quality of life of the person with diabetes. Generally, a diabetic patient measures blood glucose levels several times a day to monitor and control blood sugar levels. Failure to test blood glucose levels accurately and on a regular basis can result in serious diabetes-related complications, including cardiovascular disease, kidney disease, nerve damage and blindness. There are a number of electronic devices currently available which enable an individual to test the glucose level in a small sample of blood. One such glucose meter is the OneTouch® Profile™ glucose meter, a product which is manufactured by LifeScan.

In addition to glucose monitoring, diabetic individuals often have to maintain tight control over their lifestyle, so that they are not adversely affected by, for example, irregular food consumption or exercise. In addition, a physician dealing with a particular diabetic individual may require detailed information on the lifestyle of the individual to provide effective treatment or modification of treatment for controlling diabetes. Currently, one of the ways of monitoring the lifestyle of an individual with diabetes has been for the individual to keep a paper logbook of their lifestyle. Another way is for an individual to simply rely on remembering facts about their lifestyle and then relay these details to their physician on each visit.

The aforementioned methods of recording lifestyle information are inherently difficult, time consuming, and possibly inaccurate. Paper logbooks are not necessarily always carried by an individual and may not be accurately completed when required. Such paper logbooks are small and it is therefore difficult to enter detailed information requiring detailed descriptors of lifestyle events. Furthermore, an individual may often forget key facts about their lifestyle when questioned by a physician who has to manually review and interpret information from a hand-written notebook. There is no analysis provided by the paper logbook to distill or separate the component information. Also, there are no graphical reductions or summary of the information. Entry of data into a secondary data storage system, such as a database or other electronic system, requires a laborious transcription of information, including lifestyle data, into this secondary data storage. Difficulty of data recordation encourages retrospective entry of pertinent information that results in inaccurate and incomplete records.

There currently exist a number of portable electronic devices that can measure glucose levels in an individual and store the levels for recalling or uploading to another computer for analysis. One such device is the Accu-Check™ Complete™ System from Roche Diagnostics, which provides limited functionality for storing lifestyle data. However, the Accu-Check™ Complete™ System only permits a limited selection of lifestyle variables to be stored in a meter. There is a no intelligent feedback from values previously entered into the meter and the user interface is unintuitive for an infrequent user of the meter.

### SUMMARY OF THE DISCLOSURE

In an embodiment, a method to provide a safeguard in insulin dosing for a user with a diabetes management unit is provided. The unit includes a microprocessor coupled to a memory, display, clock, and user interface. The method can be achieved by: selecting a time period in a day from a plurality of time periods in the day for insulin bolus dosing; calculating, with the microprocessor, an insulin bolus for the user in the selected time period; comparing, with the microprocessor, the selected time period with a current time period being kept by a clock of the microprocessor; and annunciating a warning to the user when the selected period for the calculating is outside the current time period of the clock.

In yet a further embodiment, a diabetes management system is provided that includes a glucose test strip and a diabetes management unit. The diabetes management unit includes a housing, microprocessor, a plurality of user interface buttons. The housing includes a test strip port coupled to the microprocessor and configured to receive the glucose test strip. The microprocessor is coupled to the test strip port to provide data regarding an amount of glucose measured in a user's physiological fluid deposited on the test strip and coupled to the analyte measurement unit, a memory, and user interface buttons, the microprocessor programmed to: (a) allow a user to select a time period in a day from a plurality of time periods in the day for insulin bolus dosing; (b) calculate an insulin bolus for the user in the selected time period; (c) compare the selected time period with a current time period being kept by a clock of the microprocessor; and (d) annunciate a warning to the user when the selected period for the calculating is outside the current time period of the clock.

These and other embodiments, features and advantages will become apparent to those skilled in the art when taken with reference to the following more detailed description of various exemplary embodiments of the invention in conjunction with the accompanying drawings that are first briefly described.

### BRIEF DESCRIPTION OF THE FIGURES

The accompanying drawings, which are incorporated herein and constitute part of this specification, illustrate presently preferred embodiments of the invention, and, together with the general description given above and the detailed description given below, serve to explain features of the invention (wherein like numerals represent like elements).

FIG. 1A illustrates a diabetes management system that includes an analyte measurement and data management unit and data communication devices.

FIG. 1B illustrates, in simplified schematic, an exemplary circuit board of a diabetes data management unit.

FIGS. 2A, 2B, and 2C illustrate an overview of a process flow for a user interface of a diabetes data management unit.

FIGS. 3A and 3B illustrate a process flow for an insulin bolus calculation.

FIGS. 4 and 5 illustrate a process flow for setting up the insulin bolus calculation.

FIG. 6 illustrates the process of selecting an insulin calculation with built-in safeguard.

FIG. 7 illustrates various warning messages available on the diabetes management unit as part of the safeguards for the system.

FIG. 8 illustrates a process flow for determining whether to issue a warning of improperly selected time period for insulin dosing.

FIG. 9 illustrates a process flow for determining whether to issue a warning of flagged results inconsistent with current time kept by a clock of the diabetes management unit.

FIG. 10 illustrates message screens to assist a user in diabetes management.

### DETAILED DESCRIPTION OF THE EXEMPLARY FIGURES

The following detailed description should be read with reference to the drawings, in which like elements in different drawings are identically numbered. The drawings, which are not necessarily to scale, depict selected embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used herein, the terms “about” or “approximately” for any numerical values or ranges indicate a suitable dimensional tolerance that allows the part or collection of components to function for its intended purpose as described herein. In addition, as used herein, the terms “patient,” “host,” “user,” and “subject” refer to any human or animal subject and are not intended to limit the systems or methods to human use, although use of the subject invention in a human patient represents a preferred embodiment.

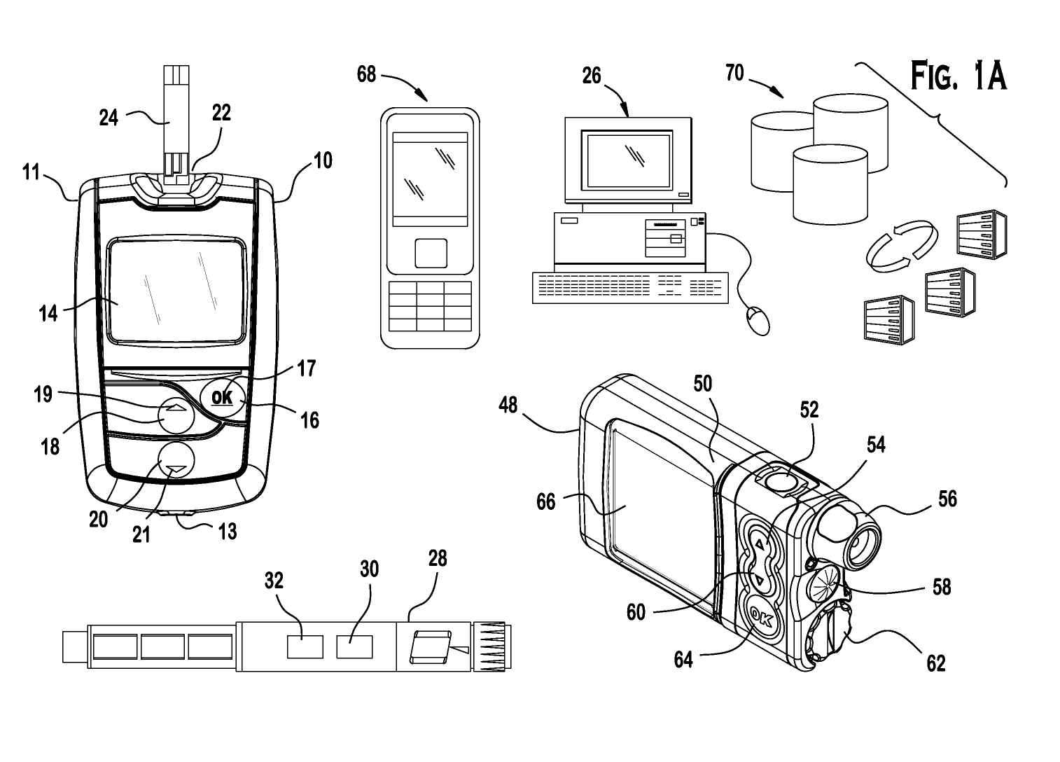

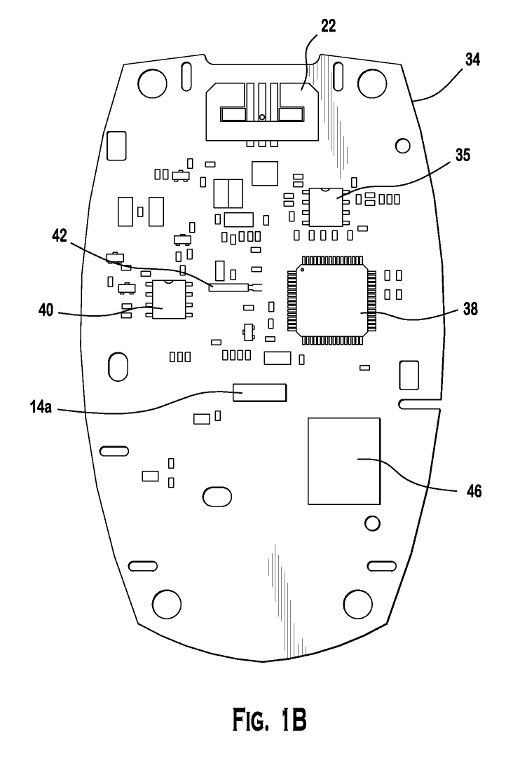

FIG. 1A illustrates a diabetes management system that includes an analyte measurement and management unit 10, therapeutic dosing devices (28 or 48), and data/communication devices (68, 26, or 70). Analyte measurement and management unit 10 can be configured to wirelessly communicate with a handheld glucose-insulin data management unit or DMU such as, for example, an insulin pen 28, an insulin pump 48, a mobile phone 68, or through a combination of the exemplary handheld glucose-insulin data management unit devices in communication with a personal computer 26 or network server 70, as described herein. As used herein, the nomenclature “DMU” represents either individual unit 10, 28, 48, 68, separately or all of the handheld glucose-insulin data management units (28, 48, 68) usable together in a disease management system. Further, the analyte measurement and management unit or DMU 10 is intended to include a glucose meter, a meter, an analyte measurement device, an insulin delivery device or a combination of an analyte testing and drug delivery device. In an embodiment, analyte measurement and management unit 10 may be connected to personal computer 26 with a cable. In an alternative, the DMU may be connected to the computer 26 or server 70 via a suitable wireless technology such as, for example, GSM, CDMA, BlueTooth, WiFi and the like.

Glucose meter or DMU 10 can include a housing 11, user interface buttons (16, 18, and 20), a display 14, a strip port connector 22, and a data port 13, as illustrated in FIG. 1A. User interface buttons (16, 18, and 20) can be configured to allow the entry of data, navigation of menus, and execution of commands. Data can include values representative of analyte concentration, and/or information, which are related to the everyday lifestyle of an individual. Information, which is related to the everyday lifestyle, can include food intake, medication use, occurrence of health check-ups, and general health condition and exercise levels of an individual. Specifically, user interface buttons (16, 18, and 20) include a first user interface button 16, a second user interface button 18, and a third user interface button 20. User interface buttons (16, 18, and 20) include a first marking 17, a second marking 19, and a third marking 21, respectively, which allow a user to navigate through the user interface.

The electronic components of meter 10 can be disposed on a circuit board 34 that is within housing 11. FIG. 1B illustrates (in simplified schematic form) the electronic components disposed on a top surface (not shown) of circuit board 34, respectively. On the top surface, the electronic components include a strip port connector 22, an operational amplifier circuit 35, a microcontroller 38, a display connector 14a, a non-volatile memory 40, a clock 42, and a first wireless module 46. Microcontroller 38 can be electrically connected to strip port connector 22, operational amplifier circuit 35, first wireless module 46, display 14, non-volatile memory 40, clock 42, and user interface buttons (16, 18, and 20).

Operational amplifier circuit 35 can include two or more operational amplifiers configured to provide a portion of the potentiostat function and the current measurement function. The potentiostat function can refer to the application of a test voltage between at least two electrodes of a test strip. The current function can refer to the measurement of a test current resulting from the applied test voltage. The current measurement may be performed with a current-to-voltage converter. Microcontroller 38 can be in the form of a mixed signal microprocessor (MSP) such as, for example, the Texas Instrument MSP 430. The MSP 430 can be configured to also perform a portion of the potentiostat function and the current measurement function. In addition, the MSP 430 can also include volatile and non-volatile memory. In another embodiment, many of the electronic components can be integrated with the microcontroller in the form of an application specific integrated circuit (ASIC).

Strip port connector 22 can be configured to form an electrical connection to the test strip. Display connector 14a can be configured to attach to display 14. Display 14 can be in the form of a liquid crystal display for reporting measured glucose levels, and for facilitating entry of lifestyle related information. Display 14 can optionally include a backlight. A data port can be provided to accept a suitable connector attached to a connecting lead, thereby allowing glucose meter 10 to be linked to an external device such as a personal computer. The data port can be any port that allows for transmission of data such as, for example, a serial, USB, or a parallel port. Clock 42 can be configured to keep current time related to the geographic region in which the user is located and also for measuring time. The DMU can be configured to be electrically connected to a power supply such as, for example, a battery.

In one exemplary embodiment, test strip 24 can be in the form of an electrochemical glucose test strip. Test strip 24 can include one or more working electrodes and a counter electrode. Test strip 24 can also include a plurality of electrical contact pads, where each electrode can be in electrical communication with at least one electrical contact pad. Strip port connector 22 can be configured to electrically interface to the electrical contact pads and form electrical communication with the electrodes. Test strip 24 can include a reagent layer that is disposed over at least one electrode. The reagent layer can include an enzyme and a mediator. Exemplary enzymes suitable for use in the reagent layer include glucose oxidase, glucose dehydrogenase (with pyrroloquinoline quinone co-factor, “PQQ”), and glucose dehydrogenase (with flavin adenine dinucleotide co-factor, “FAD”). An exemplary mediator suitable for use in the reagent layer includes ferricyanide, which in this case is in the oxidized form. The reagent layer can be configured to physically transform glucose into an enzymatic by-product and in the process generate an amount of reduced mediator (e.g., ferrocyanide) that is proportional to the glucose concentration. The working electrode can then measure a concentration of the reduced mediator in the form of a current. In turn, glucose meter 10 can convert the current magnitude into a glucose concentration. Details of the preferred test strip are provided in U.S. Pat. Nos. 6,179,979; 6,193,873; 6,284,125; 6413410; 6475372; 6716577; 6749887; 6863801; 6890421; 7045046; 7291256; 7498132, all of which are incorporated by reference in their entireties herein.

Referring back to FIG. 1A, insulin pen 28 can include a housing, preferably elongated and of sufficient size to be handled by a human hand comfortably. The device 28 can be provided with an electronic module 30 to record dosage amounts delivered by the user. The device 28 may include a second wireless module 32 disposed in the housing that, automatically without prompting from a user, transmits a signal to first wireless module 46 of the DMU 10. The wireless signal can include, in an exemplary embodiment, data to (a) type of therapeutic agent delivered; (b) amount of therapeutic agent delivered to the user; or (c) time and date of therapeutic agent delivery.

In one embodiment, a therapeutic delivery device can be in the form of a “user-activated” therapeutic delivery device, which requires a manual interaction between the device and a user (for example, by a user pushing a button on the device) to initiate a single therapeutic agent delivery event and that in the absence of such manual interaction delivers no therapeutic agent to the user. A non-limiting example of such a user-activated therapeutic agent delivery device is described in co-pending U.S. Non-Provisional application Ser. No. 12/407,173 (tentatively identified by Attorney Docket No. LFS-5180USNP); 12/417,875 (tentatively identified by Attorney Docket No. LFS-5183USNP); and 12/540,217 (tentatively identified by Attorney Docket No. DDI-5176USNP), which is hereby incorporated in whole by reference. Another non-limiting example of such a user-activated therapeutic agent delivery device is an insulin pen 28. Insulin pens can be loaded with a vial or cartridge of insulin, and can be attached to a disposable needle. Portions of the insulin pen can be reusable, or the insulin pen can be completely disposable. Insulin pens are commercially available from companies such as Novo Nordisk, Aventis, and Eli Lilly, and can be used with a variety of insulin, such as Novolog, Humalog, Levemir, and Lantus.

Referring to FIG. 1A, a therapeutic dosing device can also be a pump 48 that includes a housing 50, a backlight button 52, an up button 54, a cartridge cap 56, a bolus button 58, a down button 60, a battery cap 62, an OK button 64, and a display 66. Pump 48 can be configured to dispense medication such as, for example, insulin for regulating glucose levels.

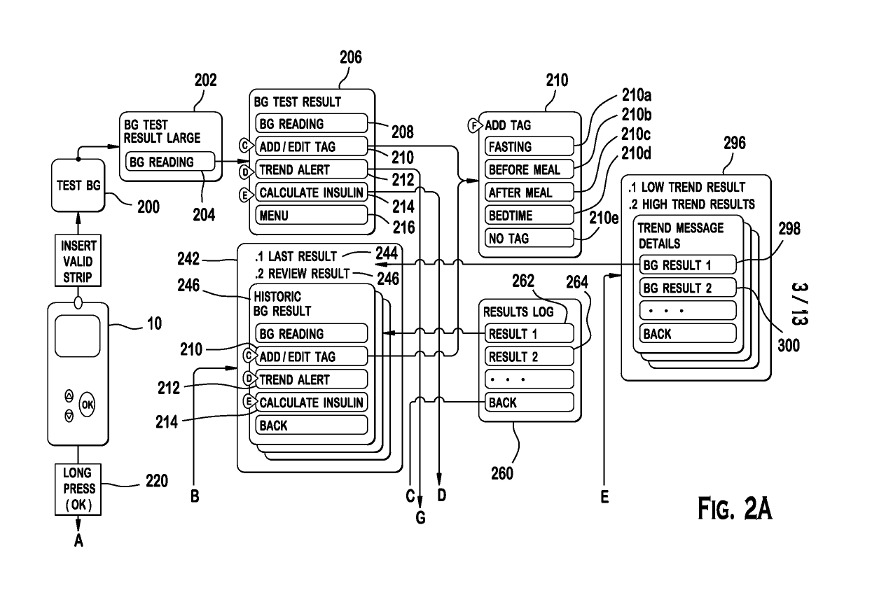

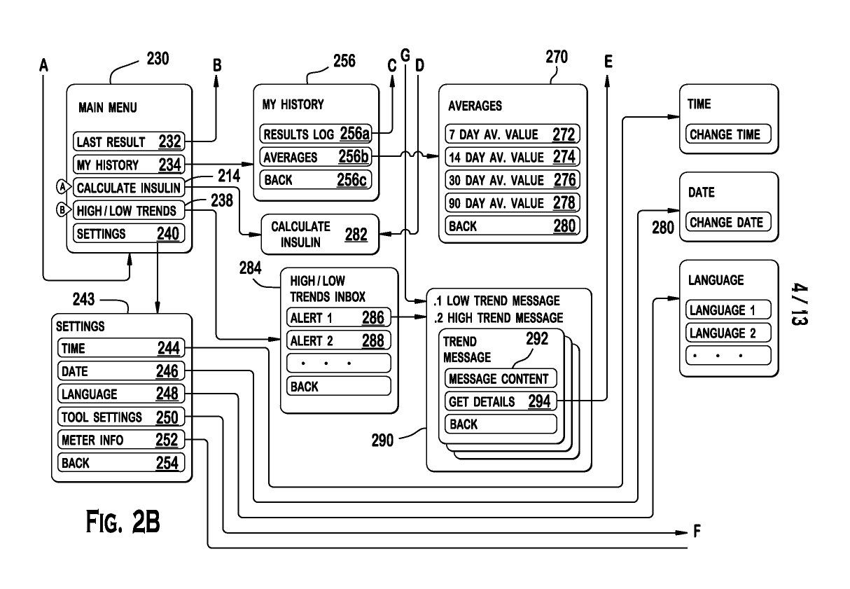

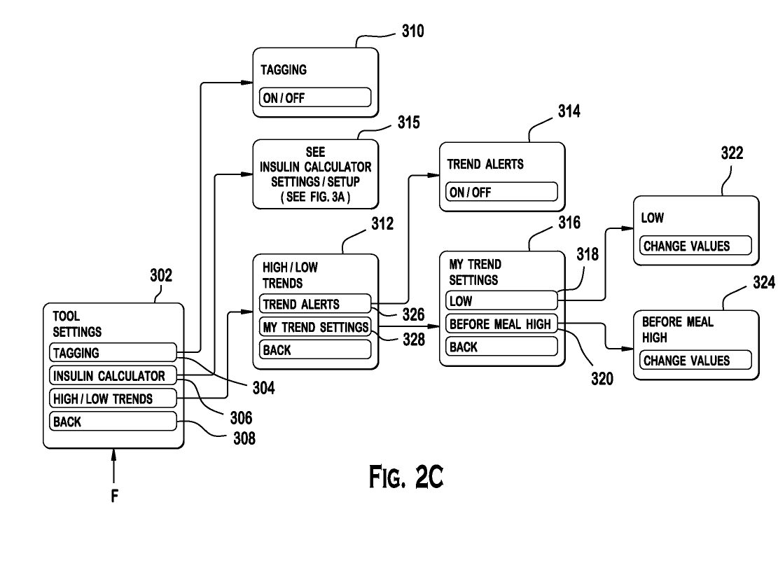

Referring to FIGS. 2A, 2B, and 2C, an exemplary process flow of portions of the user interface for the DMU is provided. Specifically, in FIG. 2A, the process flow begins at 200 when a suitable test strip 24 is inserted into the DMU 10. A blood glucose (“BG”) result at 202 is annunciated to the user. As used here, the term “annunciated” and variations on the root term indicate that an announcement may be provided via text, audio, visual or a combination of all modes of communication to a user. The BG reading 204 is stored for use in screen 206 which allows the user to scroll through a menu starting with a recall of a previous BG result 208, adding or editing a tag or flag 210, obtaining a trend alert 212, calculate insulin bolus 214, and returning to a main menu 216. Some of the functionalities 212-214 on the menu 206 may not be available depending on whether one or more of such functionalities have been enabled in the main menu. Where an edit to or addition of a flag 210 is desired for a BG result, the following selections are available: a fasting flag 210a (e.g., a BG result obtained during a fasting period of at least 6-8 hours); a before meal flag 210b (e.g., a BG result obtained prior to a meal); an after meal flag 210c; a bedtime flag 210d or no tag 210e.

Where the user desires to access a main menu of the DMU, an actuation of one of the buttons of the DMU over a long duration (e.g., greater than 2 seconds) can be utilized to allow access to the main menu 230 in FIG. 2B. In main menu 230, the following functionalities may be available to the user or a health-care-provider (“HCP”): last result 232, historical BG results 234, calculate insulin dosing 214, provide indicator of high or low trends 238, and device settings 240. Should a last result 232 be selected, the process flows to results screen 242. In this screen 242, the following functionalities are available to the user: a last BG result 244 or historical results 246. In screen 246, the last BG reading is provided along with the ability to select an add or edit of tag 210, trend alert 212, calculate insulin 214, or returning to previous menu screen 230.

Referring to FIG. 2B, the remainder of the available functionalities of screen 230 will be described. Where a history of the BG results are desired, screen 256 is provided to allow for selection of a log of results 256a collected by the DMU; averages of the BG results 256b based on user's defined parameters. As is the norm for user interfaces, a previous screen selection 256c is also provided. Where the results log 256a is selected, screen 260 (FIG. 2A) is provided that annunciates a range of results 262, 264 and subsequent series of results. Referring back to FIG. 2B, where the averages 256b of the results stored in the device are desired, screen 270 is provided that allows for a display of various ranges of average BG results. For example, a 7-day average; 14-day average; 30-day average; 90-day average are provided; any range as desired by the user or HCP. Alternatively, a median for each of the pre-defined date ranges may also be provided in addition to the average for each of the date ranges.

Where the user desires to calculate insulin bolus, the device can activate a calculation protocol 282 to provide a calculated insulin bolus. Three types of insulin boluses are described herein: (a) carbohydrate coverage, (b) glucose correction, or (c) a combination thereof. The insulin bolus amount for carbohydrate coverage may be an amount of insulin needed to account for carbohydrates about to be consumed at a meal. The insulin bolus amount for a glucose measurement correction may be an amount of insulin needed to account for a user's measured glucose value that is greater than a targeted euglycemic glucose value. The combination (e.g., carbohydrate value and measured glucose value) correction may be an amount of insulin needed to account for carbohydrates about to be consumed and the user's measured glucose value.

The glucose correction dose is an amount of insulin needed to account for a user's recently measured glucose value that is greater than the euglycemic zone. The carbohydrate coverage dose is an amount of insulin calculated based on the amount of carbohydrates to be consumed. The combination (e.g., carbohydrate value and measured glucose value) correction may be an amount of insulin needed to account for carbohydrates about to be consumed and the user's measured glucose value.

An embodiment of a glucose correction dose (“GCD”) is shown in Equation 1.

GCD=(Current BG−Target BG)×Insulin Sensitivity Factor Eq. 1

The GCD may be the amount of insulin needed to adjust the current measured glucose value or concentration to the euglycemic zone. The Current BG and Target BG may be the current measured glucose value or concentration and the target glucose value or concentration, respectively. The Insulin Sensitivity Factor or Correction Factor may be a constant that is special to the user that relates to the proportional effectiveness of insulin.

The insulin bolus amount for carbohydrate coverage dose (“CCD”) may be calculated by using Equation 2.

Insulin bolus amount for CCD=Carbohydrate Estimate×Insulin-to-Carbohydrate Ratio Eq. 2

The Carbohydrate Estimate may be the amount consumed by the user and the Insulin-to-Carbohydrate Ratio may be a constant that is special to the user relating to the proportional effectiveness of insulin on consumed carbohydrates. A total insulin dose may be calculated by summing together the GCD and the CCD.

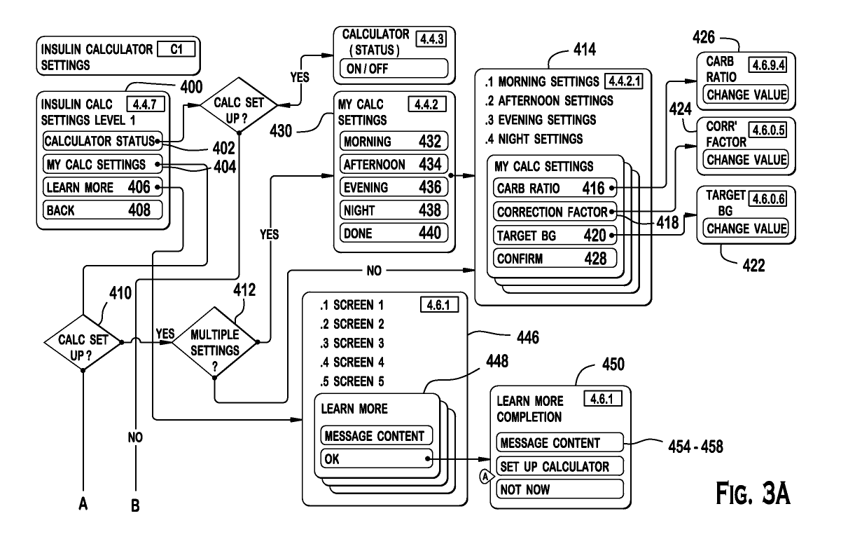

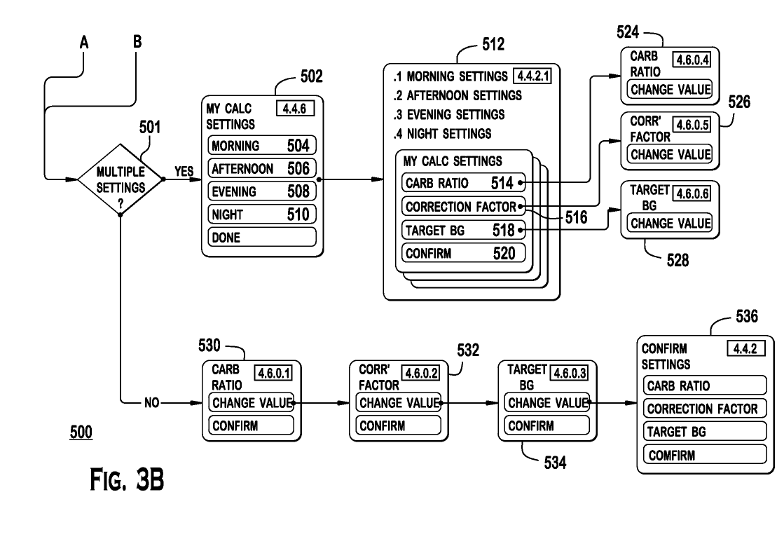

Referring back to FIG. 2B, screen 230 allows for the user to select a high/low trends screen 284. Screen 284 allows the user to view the various alerts 286, 288 and subsequent series, provided to the user. Selection of a specific alert, for example, alert 286 allows the user to view screen 290 which includes message content 292, and details of the message 294. Selection of details 294 allows the user to proceed to screen 296 which includes a history of BG results 298, 300, and subsequent series of results.

Where a device setting 240 is desired, screen 242 is provided to allow for the selection of the following user's adjustable settings: time 244, date 246, language 248, and tool settings 250. A device information selection 252 and a previous screen selection 254 are also provided in screen 242. The tool setting selection 250 allows the user or a HCP to set up the DMU 10 for the user. In particular, once tool setting functionality 250 is selected, screen 302 is provided to allow for selection of various settings including set up for tagging or flagging field 304; set up for insulin calculation field 306; and set up for high/low trends field 308. To turn on the tagging or flagging function, screen 310 allows for the user to turn this feature on or off by scrolling a pointer over to field 304 in screen 302. To modify the insulin calculation, the user must scroll a pointer to field 306 for the process flow to switch over to screen 400 (FIG. 3A). To modify the high/low trends alert, the user must scroll a pointer to field 308 for the process flow to switch over to a screen 312. Once high/low trends 308 is selected, screen 312 is provided to allow for selection of various settings including Trend Alerts 326 and My Trend Settings 328. To activate Trend Alerts 326, screen 314 allows for the user to turn this feature on or off. Modification to the thresholds can be made via screen 316 by selection of field 318 to modify a prestored low threshold at screen 322, or by selection of field 320 to modify a prestored high setting by selection of field 320.

Referring to FIG. 3A, an overview of an insulin calculation set up will now be described. Upon selection of field 306 in FIG. 2C, screen 400 is presented with four selection fields: calculator status 402, calculator setting 404, instructional help 406; and a return to previous screen 408. Upon selection of field 402, a determination is made as to whether the insulin calculator has been set up by logical operator 410. If the calculator has never been set up such as during for example, a first use of the DMU, the process flows to an initial set up logical operator 501 in FIG. 3B.

In FIG. 3B, the initial set up flows to logic operator 501 where it is determined which of a single setting (e.g., constant parameters for insulin calculation) or multiple settings (e.g., customized parameters for different time periods of dosing) were made. For multiple settings, the logic flows to menu screen 502 in which different fields are available for selection: morning setting 504, afternoon setting 506, evening setting 508, night setting 510, and a previous screen selection. For each of the settings 504, 506, 508, and 510, which are selected, another menu screen 512 is provided for selection of parametric fields relating to, for example, carbohydrate ratio 514, correction factor 516 and target BG 518. A confirmation field 520 is provided to signify completion of parametric fields. For each of fields 514, 516, and 518 that is selected, a corresponding screen from edit screens 524, 526, and 528 is provided for the user to change the existing parameter (e.g., carbohydrate ratio, correction factor, or target BG). For an insulin calculator set up with only a single setting, the logic flows from decision 501 to screens 530, 532, and 534 for the user to change the parameters relating to, for example, carbohydrate ratio, correction factor, and target BG. Once the values of the parameters have been changed or simply confirmed, a confirmation screen 536 provides all the parameters to be used in the insulin calculation to the user. It is noted that while only three parameters are described herein, many more parameters may be utilized as needed for insulin dosing depending upon the requirements of the user with diabetes.

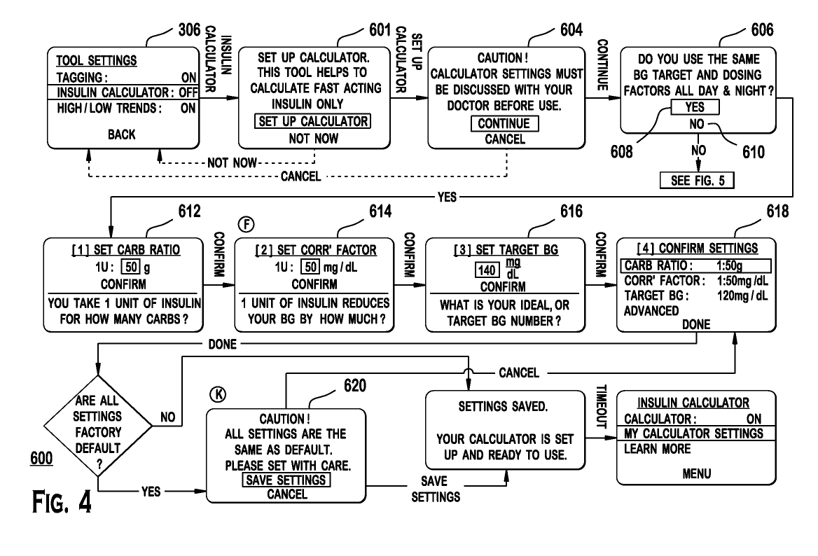

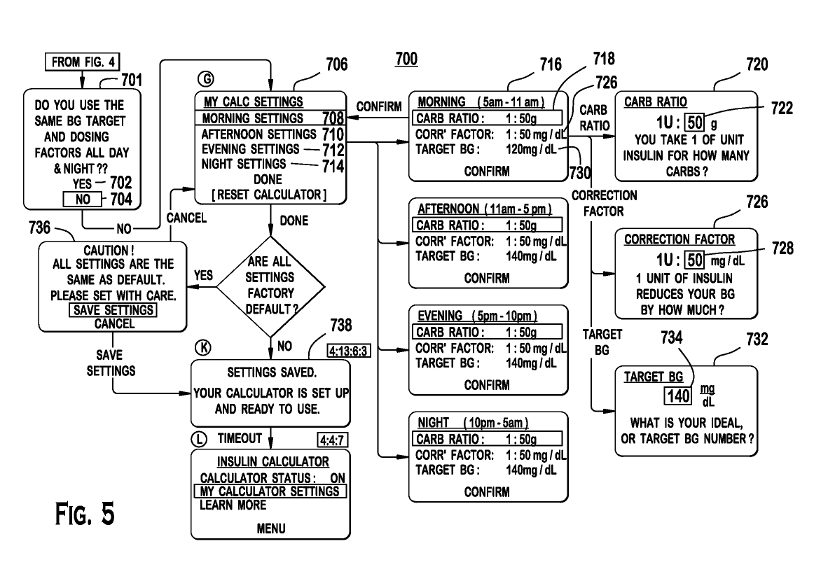

FIG. 4 illustrates exemplary details of the set-up process 600 for a first time use that is similar to the set up process 500 in FIG. 3B. In set up process 600, upon selection of field 306, a set up screen 601 is provided in which the user is able to decide whether to set up the insulin calculator or to defer the set up. Upon selection of field 602, a warning screen 604 is provided that suggests to the user to consult with a HCP. Upon the user deciding to continue with the set up, screen 606 is generated to help guide the user in the set up process. Field 608 allows the user to continue setting up the single setting whereas field 610 allows the user to select a setup for the multiple settings in FIG. 5. Where the user selected a single setting, screens 612, 614, and 616 allow the user to select the carbohydrate ratio (screen 612), insulin-sensitivity or “correction” factor (screen 614) and target BG (screen 616). Note that on screens 612, 614, and 616, there is a definition of the particular setting value (carbohydrate ratio, “correction” factor, and target BG) to help guide the user or HCP to properly populate the particular setting value. In screen 612, the message “You can take 1 unit of insulin for how many carbs?” helps guide the user to the definition of the carbohydrate ratio. In screen 614, the message “1 unit of insulin reduces your BG by how much?” helps guide the user to the definition of the correction factor. In screen 614, the message “What is your ideal or Target BG number?” helps guide the user to the definition of the Target BG number. A confirmation screen 618 is also provided for a final confirmation of selected parameters. Thereafter, the microprocessor compares the settings to determine if the parameters are the same as factory preset parameters or different. If the user selected parameters are the same as the factory default parameters, a warning screen 620 is provided with nevertheless the ability to save the parameters or return to confirmation screen 618 for editing of the parameters. Where the user's parameters are not factory preset, the parameters are saved into the single setting mode and the insulin calculator is now ready for use.

The insulin to carbohydrate ratio, insulin sensitivity value (e.g., correction factor), and target blood glucose value may be adjusted by the user or HCP. The insulin to carbohydrate ratio may be set to about 1 unit: 2 grams to about 1 unit: 50 grams in increments of 1 gram. The insulin sensitivity factor may be set to about 1 unit: 10 mg/dL to about 1 unit: 150 mg/dL in increments of 5 mg/dL. The target blood glucose value may be set to about 80 mg/dL to about 240 mg/dL in increments of 5 mg/dL. The default values for the insulin to carbohydrate ratio, insulin sensitivity value (e.g., correction factor), and target blood glucose value, may be set to values that mitigates the possibility of a user causing a hypoglycemic event as a result of an insulin bolus, but still allows for effective insulin therapy. In an embodiment, the default values for the insulin to carbohydrate ratio, insulin sensitivity value (e.g., correction factor), and target blood glucose value may be set to about 1 unit: 50 grams, 1 unit: 150 mg/dL, and 240 mg/dL, respectively.

FIG. 5 illustrates the process flow 700 for setting up the multiple settings in the event that the process flow from screen 606 (FIG. 4) indicates that the user is not selecting a single setting setup. In FIG. 5, screen 701 allows the user to return to the single setting with selection 702 otherwise the user may select 704 to move to the next screen 706. Screen 706 provides for four different time periods 708, 710, 712, and 714 in a 24-hour day where each time period is provided with time period specific parameters (e.g., carbohydrate ratio; correction factor; and target BG) such as, for example, the morning time period in screen 716. In screen 716, each parameter, once selected at screen 716, is provided with its own input screen (720, 727, and 732) in FIG. 5. For example, where the carb ratio 718 is selected (by scrolling to highlight the field and then selected by pressing the OK button on the DMU 10), FIG. 5 shows screen 720 being displayed to allow the user to change the particular parameter 722 from a factory preset parameter, which in this case is 1:50 grams. Similarly, where the correction factor 726 is desired to be changed from its factory preset parameter of 1:50 mg/dL, correction factor 726 is selected which provides for screen 727 with parameter 728 changeable by the user. Likewise, where target BG 730 is desired to be changed from its factory preset parameter of 120 mg/dL, target BG field 730 is highlighted and selected for display of screen 732 to allow parameter 734 to be changed from the factory preset value of 120 mg/dL. This set up process from screen 706 is made to the four exemplary time periods. Upon completion, the parameters for each time period are stored. Thereafter, the microprocessor is configured to determine whether the parameters in each time period correspond to the factory presets and if true, a message is provided at screen 736 to warn the user of the same. If the user intended to utilize the factory presets, the user is allowed to save the multiple settings with display of screen 738.

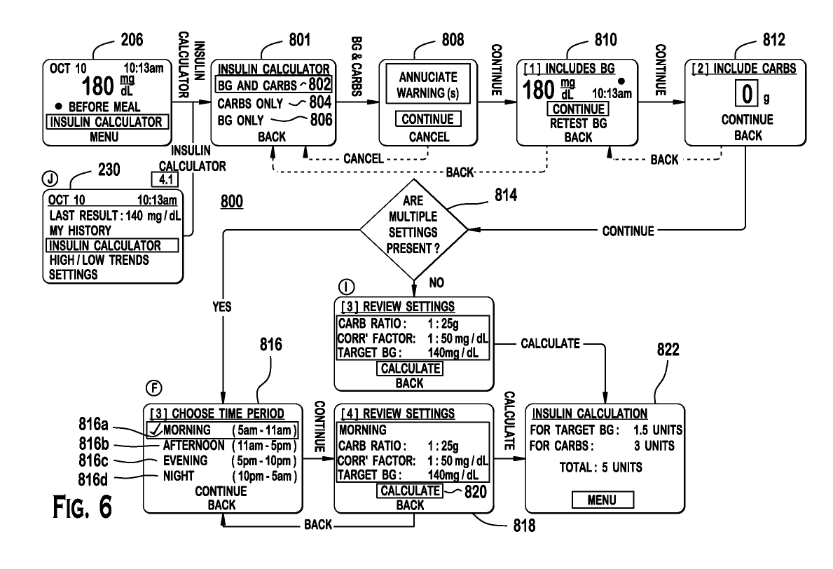

Referring back to FIG. 3A, assuming that the insulin calculator 400 has been set up as described in FIGS. 3A, 3B, 4, and 5, the logical operator 412 determines whether the insulin calculator 400 is set up for single setting or multiple setting. Where only the single setting has been selected, the user is provided with screen 414 to allow for viewing of the parameters utilized in the single setting type insulin bolus calculation. Each of the parameters, for example, carbohydrate ratio 416, correction factor 418, or target BG 420, can be viewed or changed by scrolling to highlight the parameter and selecting the parameter, shown here in screens 422, 424, and 426. A confirmation field 428 allows the user to confirm the parameters used for calculating the insulin bolus. Where a multiple setting has been selected in the set up process of FIGS. 3A, 3B, 4, and 5, the logic proceeds to screen 430. Screen 430 provides a plurality of time periods for which insulin bolus can be calculated including, for example, morning setting 432, afternoon setting 434, and evening setting 436, night setting 438. The user can save all settings with selection field 440. The user can also reset all of the settings to factory defaults with selection field 620 (FIG. 6). Selection of any of the parametric fields 432-436 will cause the process to the same process as described earlier for a single setting. As an example, the evening setting 436 could be selected at which point the process flows to screen 414 to allow for viewing of the parameters utilized for each parameter in the insulin bolus calculation for the evening setting. Each of the parameters, for example, carbohydrate ratio 416, correction factor 418, or target BG 420, can be viewed or changed by scrolling to highlight the parameter and selecting the parameter, shown here in screens 422, 424, and 426. A confirmation field 428 allows the user to confirm the parameters used for calculating the insulin bolus.

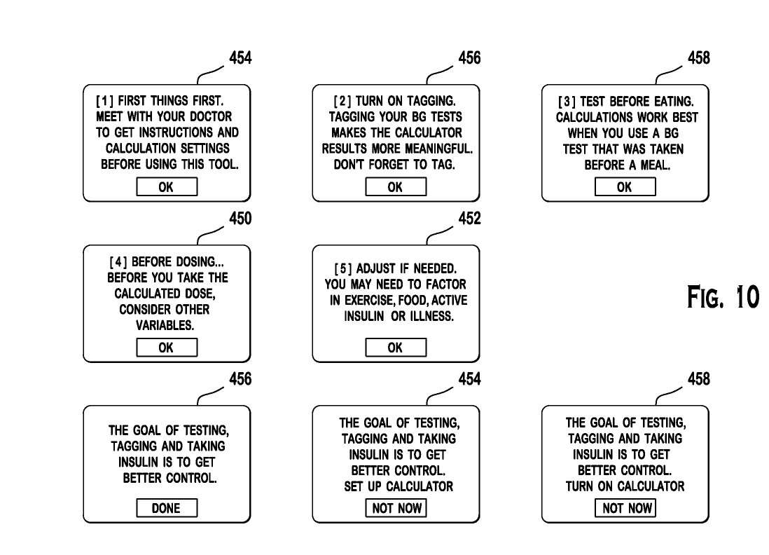

Should the user desire to understand more of the insulin bolus calculation, menu screen 446 is provided, which lists out topical areas 448 for the user to learn more about the insulin bolus, shown here in FIG. 10. In FIG. 10, the user is provided with a guided description of various functionalities and warnings regarding the use of the insulin bolus calculator. For example, screen 454 provides a warning message to see a HCP before setting up the calculator. A suggestion screen 456 for the user to turn on tagging of BG values is provided to the user for selection. Once tagging has been selected, another suggestion screen 458 to suggest testing prior to a meal is provided. Upon acceptance of the message, suggestion screens 450 and 452 are provided for the user to consider other factors involved in insulin dosing. In the event that the insulin calculator 400 has been set up, a reminder message is provided on screen 456 as to the reason for testing and dosing insulin is provided. Where the calculator 400 has not been set up, the user is provided with a choice of setting up the calculator or deferring the set up in screen 454. Where the calculator 400 has been set up but not turned on for use, the user is prompted to turn on the calculator 400 in screen 458.

Referring back to FIG. 2A, the user or HCP can access the insulin calculation functionality by (a) selecting the insulin calculation immediately after a BG measurement is made as shown in process flow at 200, 202 and 206, or (b) selecting the main menu screen 230 in the process flow (FIG. 2B) and selecting the insulin calculation field 214. Regardless of which route was undertaken, upon selection of field 214 in screen 206 or screen 230, the insulin calculation process 800 of FIG. 6 is utilized.

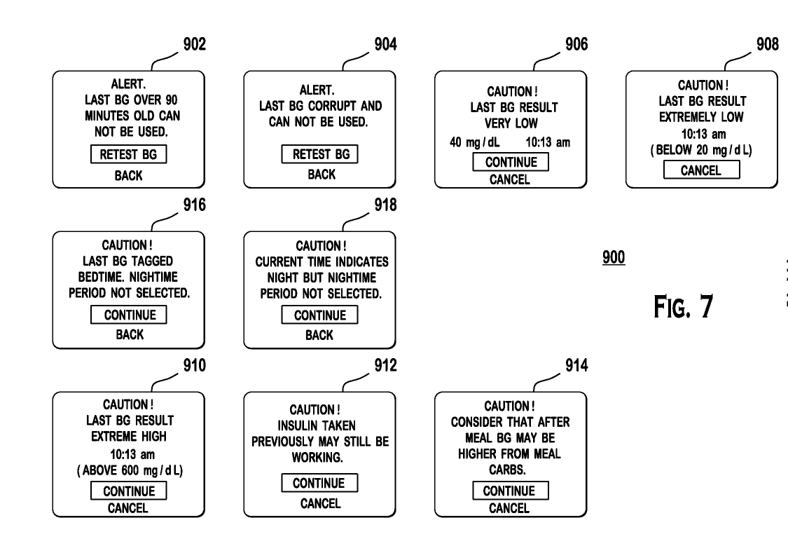

As noted earlier, screen 801 of process 800 in FIG. 6 is reached from either screen 206 (FIG. 2A) or screen 230 (FIG. 2B). Screen 801 allows the user to select insulin calculation that takes into account a measured BG result and carbohydrates to be consumed at field 802, for carbohydrate only field 804, or for BG result only field 806. Background processes may be running at this point and if suitable, warning messages 900 (FIG. 7) may be provided at this screen 808.

Referring to FIG. 7, the warning messages 900 may include a first retest alert 902 that the last BG has exceeded a first time threshold; a second retest alert 904 in that the last BG result is corrupted (i.e., when the meter software detects corruption of the blood glucose record and therefore is unable to retrieve the data, and is detected by performing a sum check on the data of the glucose record); a warning 906 that the last BG result is lower than a predetermined threshold; a warning 908 that the last BG result is lower than a second predetermined threshold lower than the first threshold; a warning 910 that the last BG result is higher than a third predetermined threshold; a warning 912 that a recently infused or injected dose of insulin may still be physiologically active in the user's body; a warning 914 that the BG result from an after meal may be higher due to the carbohydrates in the meal; a warning 916 that the BG result flagged as bedtime does not match the time period selected for insulin calculation; and a warning 918 that the internal clock of the current time in the diabetes management unit does not match the time period selected for insulin calculation. In an embodiment, the insulin calculator may be de-activated or locked out when there is an extreme low glucose concentration as shown in message 908. However, for message 910, when there is an extreme high glucose concentration, the insulin calculator will not be de-activated. In an embodiment, the insulin calculator may be de-activated or locked out when the current glucose measurement is flagged as after meal, as shown in message 914. Users should use a before meal glucose concentration for the insulin calculator because an after meal glucose concentration may be higher from meal carbohydrates. In an embodiment, message 912 may be displayed while using the insulin calculator when the insulin calculator was used within the last about one to about six hours or that a glucose measurement was flagged as pre-meal within the about last about one to about six hours. Details of the logic underlying the output of the messages 902, 904, 906, 908, 910, 912, and 914 are provided in U.S. Provisional Patent Applications Ser. No. 61/246,630 (Attorney Docket No. DDI-5190) filed 29 Sep. 2009 and Ser. No. 61/297,573 (Attorney Docket No. LFS-5211) filed 22 Jan. 2010, all of the applications are hereby incorporated into this application.

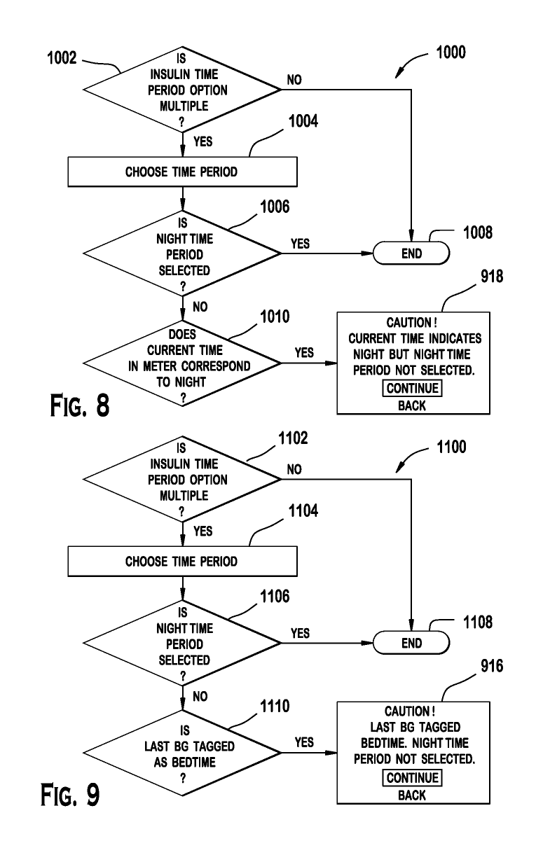

For message 916 to be annunciated to the user, logical process 1000 is utilized as described in FIG. 8. In process 1000, the processor 38 determines at logical operator 1002 if the user had previously selected multiple settings for insulin calculation. Should this be true, the process flows to a system check 1004 of the current time stored by the clock of the processor. Subsequently, the logic flows to logical operator 1006 where the processor determines whether the user had selected one of the plurality of time periods for insulin calculation, for example, a nighttime period, that falls within the current time. If the operation returns a yes, meaning that the current time is within the selected nighttime then the process ends at 1008. On the other hand, if the user had not selected a time period consistent with the current time then at 1010, the system determines whether the current time correspond to one of the plurality of time periods and provide a warning message that the current time indicates one of the plurality of time periods (in this case nighttime) but the one time period (e.g., nighttime period) has not been selected.

For message 918 to be annunciated to the user, logical process 1100 is utilized as described in FIG. 9. In process 1100, the processor 38 determines at logical operator 1102 if the user had previously selected multiple settings for insulin calculation. Should this be true, the process flows to a system check 1104 of the current time stored by the clock of the processor. Subsequently, the logic flows to logical operator 1106 where the processor determines whether the user had selected one of the plurality of time periods for insulin calculation, for example, a nighttime period, that falls within the current time. If the operation 1106 returns a yes, meaning that the current time is within the selected nighttime then the process ends at 1108. On the other hand, at 1106, if the user had not selected a time period from the plurality of time periods consistent with the current time on the diabetes management unit then a query is made to determine if a flag relating to the current time period has been made. If the operation is true at 1110 then a warning message is annunciated to indicate that the BG result is flagged as within a given time period (e.g., bedtime) but a setting for the corresponding time period (e.g., night time for insulin calculation) has not been selected or inconsistent with the selected time period for insulin calculation.

Referring back to FIG. 6, after the annunciating of messages, the process continues to screen 810 that, depending on whether field 802, 804 or 806 has been selected, allows the user to confirm that a certain field (802, 804, or 806) has been selected for insulin calculation. As the user continues through screen 812, the system checks to see if multiple settings for insulin calculation have been selected previously in FIGS. 4, and 5. If true, then the user is provided with menu screen 816 to allow the user to select an appropriate time period and a review at screen 818. Here, the user may configure at least one range of time intervals (e.g., “morning”) in a 24 hour time period as one of the plurality of time periods. The system or the user may define respective time intervals for a morning period 816a, afternoon period 816b, evening period 816c, and night period 816d in a 24 hour time period. In a preferred embodiment, the morning period is predefined from about 5 AM to about 11 AM; the afternoon period is predefined from about 11 AM to about 500 PM, the evening period from about 5 PM to about 10 PM, and the night period from about 10 PM to about 500 AM. Upon the user selecting the calculation field 820, the system calculates the appropriate insulin bolus and provides an output at screen 822.

In operation, the system of FIG. 1A, at a minimum, include a glucose test strip and a diabetes management unit. The diabetes management unit 10 may include a housing that has a test strip port 22 coupled to microprocessor 38. The port 22 is configured to receive a test strip and the microprocessor 38 is electrically coupled to the test strip port 22 to provide data regarding an amount of glucose measured in a user's physiological fluid deposited on the test strip 24. The diabetes management unit also includes a plurality of user interface buttons coupled to the microprocessor. The microprocessor is also coupled to a memory and programmed to: (a) allow a user (FIGS. 3A, 3B, 6) to select a time period in a day from a plurality of time periods in the day for insulin bolus dosing; (b) calculate (FIG. 6) an insulin bolus for the user in the selected time period; (c) compare the selected time period with a current time period being kept by a clock of the microprocessor (FIGS. 8 and 9); and (d) annunciate a warning to the user when the selected period for the calculating is outside the current time period of the clock.

By virtue of the system and process described herein, a method to provide a safeguard for insulin dosing with a diabetes management unit 10 is also provided. The method may include the steps of: selecting a time period in a day from a plurality of time periods in the day for insulin bolus dosing (FIG. 3A); calculating, with the microprocessor, an insulin bolus for the user in the selected time period (FIG. 6); comparing, with the microprocessor, the selected time period with a current time period being kept by a clock of the microprocessor (FIG. 8 or 9); and annunciating a warning to the user when the selected period for the calculating is outside the current time period of the clock (FIG. 8 or 9). The method may further include conducting a glucose measurement and flagging the measurement as related to a time period during the day (FIG. 2A). The method may further include designating an insulin to carbohydrate ratio for each of the plurality of time periods.

As noted earlier, the microprocessor can be programmed to generally carry out the steps of various processes described herein. The microprocessor can be part of a particular device, such as, for example, a glucose meter, an insulin pen, an insulin pump, a server, a mobile phone, personal computer, or mobile hand held device. Furthermore, the various methods described herein can be used to generate software codes using off-the-shelf software development tools such as, for example, C, C+, C++, C-Sharp, Visual Studio 6.0, Windows 2000 Server, and SQL Server 2000. The methods, however, may be transformed into other software languages depending on the requirements and the availability of new software languages for coding the methods. Additionally, the various methods described, once transformed into suitable software codes, may be embodied in any computer-readable storage medium that, when executed by a suitable microprocessor or computer, are operable to carry out the steps described in these methods along with any other necessary steps.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well.

What is claimed is:

1. A method to provide a safeguard in insulin dosing for a user with a diabetes management unit that includes a microprocessor coupled to a memory, display, clock, and user interface, the method comprising:
selecting a time period in a day from a plurality of time periods in the day for insulin bolus dosing;
calculating, with the microprocessor, an insulin bolus for the user in the selected time period;
comparing, with the microprocessor, the selected time period with a current time period being kept by a clock of the microprocessor; and
annunciating a warning to the user when the selected period for the calculating is outside the current time period of the clock.

2. The method of claim 1, further comprising conducting a glucose measurement and flagging the measurement as related to a time period during the day.

3. The method of claim 1, further comprising configuring at least one range of time intervals in a 24 hour time period as one of the plurality of time periods.

4. The method of claim 3, in which the configuring comprises defining respective time intervals for a morning period, afternoon period, evening period, and night period in a 24 hour time period.

5. The method of claim 4, in which the morning period is predefined from about 5 AM to about 11 AM, the afternoon period is predefined from about 11 AM to about 500 PM, the evening period from about 5 PM to about 10 PM, and the night period from about 10 PM to about 500 AM.

6. The method of claim 1, in which the calculating comprises designating an insulin to carbohydrate ratio for each of the plurality of time periods.

7. The method of claim 1, in which the calculating comprises designating a default insulin to carbohydrate ratio for each of the plurality of time periods, the default insulin to carbohydrate ratio including about one unit to about fifty grams.

8. The method of claim 7, in which the designating further comprises annunciating a definition of the insulin to carbohydrate ratio.

9. The method of claim 1, in which the calculating comprises designating an insulin sensitivity value for each of the plurality of time periods.

10. The method of claim 1, in which the calculating comprises designating a default insulin sensitivity value for each of the plurality of time periods, the default insulin sensitivity value including about one unit to about 150 milligrams per deciliter.

11. The method of claim 10, in which the designating further comprises annunciating a definition of the insulin sensitivity value.

12. The method of claim 1, in which the calculating comprises designating a target blood glucose value for each of the plurality of time periods.

13. The method of claim 1, in which the calculating comprises designating a default target blood glucose value for each of the plurality of time periods, the default target blood glucose value including about 240 milligrams per deciliter.

14. The method of claim 13, in which the designating further comprises annunciating a definition of the target blood glucose value.

15. The method of claim 1, in which the calculating comprises designating, for each of the plurality of time periods, an insulin-to-carbohydrates ratio, an insulin-sensitivity factor value, and a target blood glucose value.

16. The method of claim 1, in which the annunciating comprises displaying textual information on the display that a current time of the microprocessor is outside of the time period selected.

17. The method of claim 2, in which the annunciating comprises displaying textual information on the display that the flagging does not correspond to selected time period.

18. The method of claim 1, in which the selecting comprises pre-setting the plurality of time periods.

19. A diabetes management system comprising:
a glucose test strip; and
a diabetes management unit comprising:
a housing having a test strip port configured to receive the glucose test strip;
a plurality of user interface buttons;
a microprocessor coupled to the test strip port to provide data regarding an amount of glucose measured in a user's physiological fluid deposited on the test strip, the microprocessor further coupled to a memory, and user interface buttons; the microprocessor being programmed to:
(a) allow a user to select a time period in a day from a plurality of time periods in the day for insulin bolus dosing;
(b) calculate an insulin bolus for the user in the selected time period;
(c) compare the selected time period with a current time period being kept by a clock of the microprocessor; and
(d) annunciate a warning to the user when the selected period for the calculating is outside the current time period of the clock.

20. The system of claim 19, in which the management unit is configured to define respective time intervals for a morning period, afternoon period, evening period, and night period in a 24 hour time period.

21. The system of claim 20, in which the morning period is predefined from about 5 AM to about 11 AM, the afternoon period is predefined from about 11 AM to about 500 PM, the evening period from about 5 PM to about 10 PM, and the night period from about 10 PM to about 500 AM.

22. The system of claim 19, in which the microprocessor is programmed to designate an insulin to carbohydrate ratio for each of the plurality of time periods and an insulin sensitivity value for each of the plurality of time periods.

23. The system of claim 19, in which the microprocessor is programmed to designate a default insulin to carbohydrate ratio for each of the plurality of time periods, the default insulin to carbohydrate ratio including about one unit to about fifty grams and annunciate a definition of the insulin to carbohydrate ratio.

24. The system of claim 22, in which the microprocessor is programmed to designate a default insulin sensitivity value for each of the plurality of time periods, the default insulin sensitivity value including about one unit to about 150 milligrams per deciliter.

25. The system of claim 19, in which the microprocessor is programmed by the user to designate a target blood glucose value for each of the plurality of time periods.

26. The system of claim 19, in which the microprocessor is programmed to designate a default target blood glucose value for each of the plurality of time periods, the default target blood glucose value including about 240 milligrams per deciliter.

27. The system of claim 19, in which the microprocessor is programmed to designate, for each of the plurality of time periods, an insulin-to-carbohydrates ratio, an insulin-sensitivity factor value, and a target blood glucose value.

28. The system of claim 19, in which the microprocessor is programmed to display textual information on the display that a current time of the microprocessor is outside of the time period selected.

29. The system of claim 19, in which the microprocessor is programmed to display textual information on the display that the flagging does not correspond to selected time period.
